(19) United States
(12) Patent Application Publication
(10) Pub. No.: US 2006/0249177 A1
(43) Pub. Date: Nov. 9, 2006

(54) Duct Cleaning Brush

(76) Inventor: George Robert Guajardo, Galveston, TX (US)

Correspondence Address: Mark L. Cooper, Esq., Suite 325, 2200 Market Street, Galveston, TX, 77554, US

(21) Appl. No.: 11/430,544

(22) Filed: May 8, 2006

Related U.S. Application Data
(60) Provisional application No. 60/678,684, filed on May 9, 2005.

(51) Int. Cl. B08B 9/04

(52) U.S. Cl. 134/8; 15/104.09

(57) ABSTRACT

Disclosed herein is a duct cleaning brush comprising a hub having a hub face connecting a plurality of hub sides radially disposed about a central axis and at least one front polymeric strand extending in a longitudinal direction outward from said hub face. A method of cleaning a duct using the above duct cleaning brush is also disclosed.

### RELATED APPLICATIONS

This application claims the benefit of U.S. Provisional Application Ser. No. U.S. 60/678,684 filed May 9, 2005.

### BACKGROUND OF THE INVENTION

The present disclosure generally relates to an apparatus and method for cleaning ductwork. More specifically, the present disclosure relates to an apparatus and method relating to a duct cleaning brush useful for removing debris from air and exhaust ducts.

Ductwork exists in essentially every modern dwelling. Ducts provide conduits which may allow fresh air into a dwelling, and which may allow exhaust air out of a dwelling or other structure. Contaminates in fresh air and/or debris in exhaust air (or other gases) may however accumulate on the inner surfaces of a duct. Periodic cleaning of such debris and contaminates wherein the contaminants are removed from within the duct may be necessary to prevent restriction of flow in or out of the duct.

Various means have been used to clean ductwork. Devices typically include a cleaning head which may be attached to a vacuum hose. The cleaning head may be a power driven rotary brush, driven by a shaft connected to a remote power source. The cleaning head with its rotary brush and optionally a vacuum hose may be forced to travel through the ductwork, including around various bends. Necessarily, the shaft from the power source and the vacuum hose must be flexible enough to allow being forced around duct bends. The rotary brush on the cleaning head may rotate as it moves through the duct-work. Debris may then be loosened from within the ductwork, and vacuumed away.

The level or amount of debris which may accumulate within a duct may depend on the type and quantity of debris which may routinely traverse the duct. The amount and type of debris within a particular duct may also depend on ancillary factors, such as the availability of a duct to provide shelter for nesting wildlife, in particular, bird nests, squirrel nests, and the like. Dryer vents are of particular concern, in that such ducts are designed to provide a conduit for a relatively dirty exhaust stream comprising lint, particulates, and the occasional article of clothing. Keeping dryer vents clean however is of the utmost importance due to the noxious components within a clothes dryer exhaust stream, the fire hazards dirty ducts present, and the availability of dryer exhaust ducts to various nesting animals.

U.S. Pat. No. 6,813,810 to Beynon (Benyon) is directed to a motorized vacuum nozzle assembly configured to suction particles from within an enclosed space (a duct), the vacuum nozzle assembly is adapted for coupling to a hose of a vacuum assembly at a leading end of the hose used for cleaning and vacuuming the enclosed space, and comprising: an electrical motor assembly configured to move a cleaning member thereby removing particles from surfaces contacted by the cleaning member; and means for coupling the motor assembly to the leading end of the hose of the vacuum assembly; wherein the means for coupling has at least one opening there through located to the rear of the motor assembly, such that particles can be suction through the at least one opening into the hose of the vacuum assembly.

Beynon requires placement of the cleaning member proximate to the vacuum hose such that the entire unit must be fed through the duct to be cleaned. The approach taught by Beynon may thus be limited in use to those applications wherein the vacuum hose may be guided through the ductwork. Furthermore, debris knocked loose by the brush must be immediately sucked into the vacuum hose before it settles back onto a wall of the duct. Proximate positioning of the rotary brush near the vacuum hose end may thus be paramount to proper operation of the device. However, rotary brushes of the type disclosed by Beynon have a dense set of bristles. The rotating bristles may thus effectively block free access to the vacuum hose end.

U.S. Pat. No. 5,608,941 to Kleinfeld (Kleinfeld) is directed to a rotary brush having a hub with a center hole for receiving a drive shaft of a power tool, an annular collar positioned over the hub, and a low density strand set of polymeric flexible strands extending from the annular collar. The collar has a set of substantially uniformly spaced radial holes to receive the strands. The strand set of polymeric flexible strands is capable of being bent axially of the annular collar so as to access the duct's interior through a small opening. The strand set is also capable of bending radially during a cleaning process. The low density of strands ensures that efficient vacuuming of debris loosened by the rotary brush is accomplished.

While the rotating bristles of Kleinfeld may allow for effective access to the vacuum hose, the brush of Kleinfeld does not provide for removal of debris directly in front of the brush. Accordingly, the brush of Kleinfeld may find limited utility in ducts which contain debris that impedes the path of the brush through the duct. Relatively large debris relative to a particular duct, which does not allow the brush to pass there through (e.g., such as a birds nest within a typical clothes dryer duct), would frustrate removal of debris from a duct according to the teachings of Kleinfeld.

As can be seen, there is a need for a duct cleaning brush which provides for removal of debris directly in front of the brush.

### SUMMARY OF THE INVENTION

In one aspect of the present invention a duct cleaning brush comprises a hub having a hub face connecting a plurality of hub sides radially disposed about a central axis and at least one front polymeric strand extending in a longitudinal direction outward from the hub face.

In another aspect of the invention, a duct cleaning brush comprises an inner hub having a center cavity for receiving a rotatable shaft; an hub positioned over, and secured to the inner hub; the hub having a hub face connecting a plurality of hub sides radially disposed about a central axis; a plurality of front polymeric strands extending in a longitudinal direction outward from the hub face; a plurality of side strands extending radially away from the hub side; the front polymeric strands and the side strands comprise a flexible monofilament polymeric chord having an average diameter of about 0.040 inches to about 0.25 inches; the front polymeric strands and the side strands each having a free end and an anchoring end, wherein the anchoring end has a larger diameter than the free end; each free end of the front polymeric strands and each free end of the side strands protruding through an opening through the hub, wherein the opening through the hub has a smaller diameter than the diameter of the anchoring end of the front polymeric strands and the side strands such that each of the anchoring ends of the front polymeric strands and the side strands engages the hub and does not pass through the openings through the hub; and the hub being positioned over the inner hub such that the inner hub frictionally engages at least one of the anchoring ends of the front polymeric strands, the side strands, or both.

In yet another aspect of the present invention, a method of cleaning a duct comprises the steps of disposing a duct cleaning brush within the duct, wherein the duct cleaning brush comprises a hub having a hub face connecting a plurality of hub sides radially disposed about a central axis and at least one front polymeric strand extending in a longitudinal direction outward from the hub face, and rotating the duct cleaning brush about the central axis within the duct such that the at least one front polymeric strand frictionally engages an inner wall of the duct.

These and other features, aspects and advantages of the present invention will become better understood with reference to the following drawings, description and claims.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only typical embodiments of the disclosure and are therefore not to be considered limiting of its scope. The invention of the present disclosure will be described and explained with additional specificity and detail through the use of the accompanying drawings in which:

FIG. 1 is a partial, perspective view of a duct cleaning brush of the present disclosure;

FIGS. 2a-2c are cross sectional side views of alternate embodiments of the present disclosure

FIG. 3 is a cross sectional side view of an embodiment of the present disclosure;

FIG. 4 is a cross sectional side view of an embodiment of the present disclosure;

FIG. 5 is an environmental view showing the brush of the present disclosure in use; and

FIG. 6 is a cutaway view of an embodiment of the present disclosure.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present disclosure generally provides a duct cleaning device comprising a duct cleaning brush having a hub having a hub face connecting a plurality of hub sides radially disposed about a central axis and at least one front polymeric strand extending in a longitudinal direction outward from the hub face. By longitudinal, it is meant the front polymeric strand extends either parallel with the central axis, or at an angle of less than 90 degrees (90°) with the central axis. The hub is preferably attachable to a rotatable shaft on a side of the hub opposite the side from which the at least one polymeric strand extends outward from. In an embodiment, the polymeric strand extends at a forward strand angle of less than 90° determined relative to the central axis of the hub. This is in contrast to the prior art wherein the strands extend radially outward from an annular collar such that the strands are essentially perpendicular to a central axis of the hub.

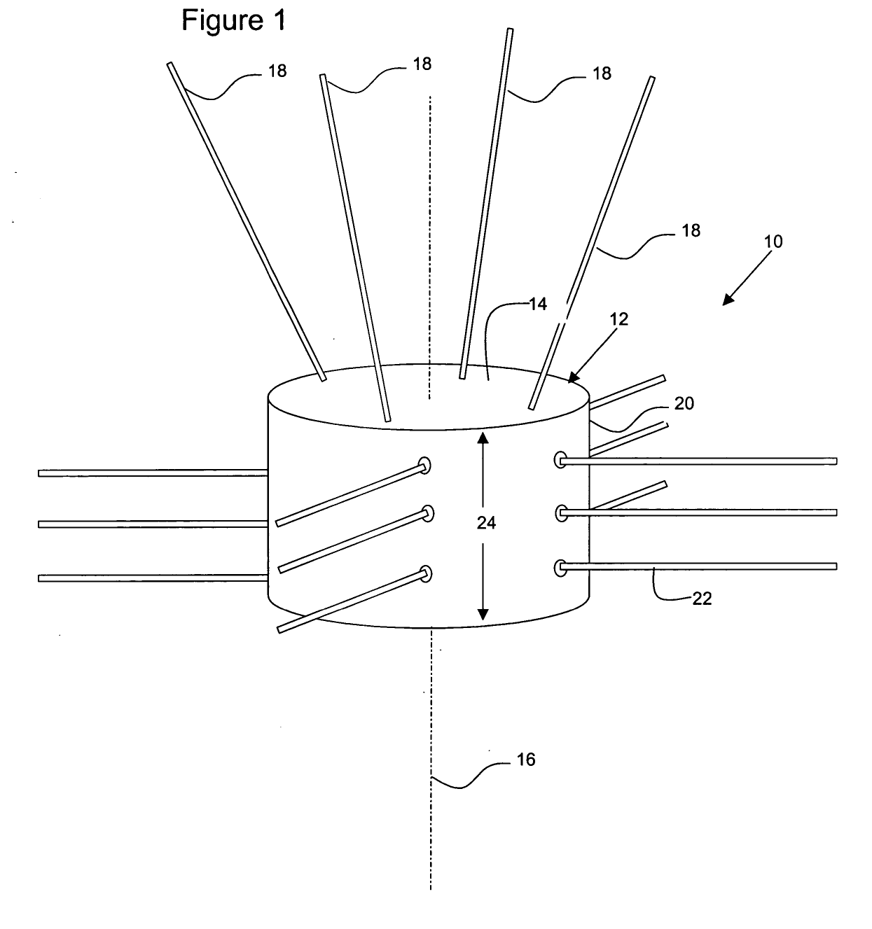

In more specifically describing the present disclosure, FIG. 1 shows a perspective drawing of an embodiment of the present disclosure wherein the brush, represented generally as 10 comprises a hub 12 having a hub face 14, which in the embodiment shown is essentially parallel to a central axis 16 of hub 12. At least one or more front polymeric strands 18 extend longitudinally outward from hub face 14.

In the embodiment shown in FIG. 1, hub 12 of the present disclosure may also comprise a plurality of hub sides 20 radially disposed about central axis 16, and having a side length 24 longitudinally disposed along central axis 16. At least one side polymeric strand 22 (only one of which is labeled in FIG. 1 for clarity) may extend from at least one hub side 20 axially away from central axis 16.

In an embodiment, hub 12 may comprise a cross section taken normal (i.e., perpendicular) to central axis 16 having 3 or more sides (e.g., triangular), preferably 4 or more sides (e.g., square or rectangular), preferably 5 or more sides, preferably 6 or more sides, preferably 8 or more sides, more preferably an infinite number of sides (e.g., circular or oval). In a preferred embodiment, hub 12 may comprise a circular cross section taken normal to central axis 16.

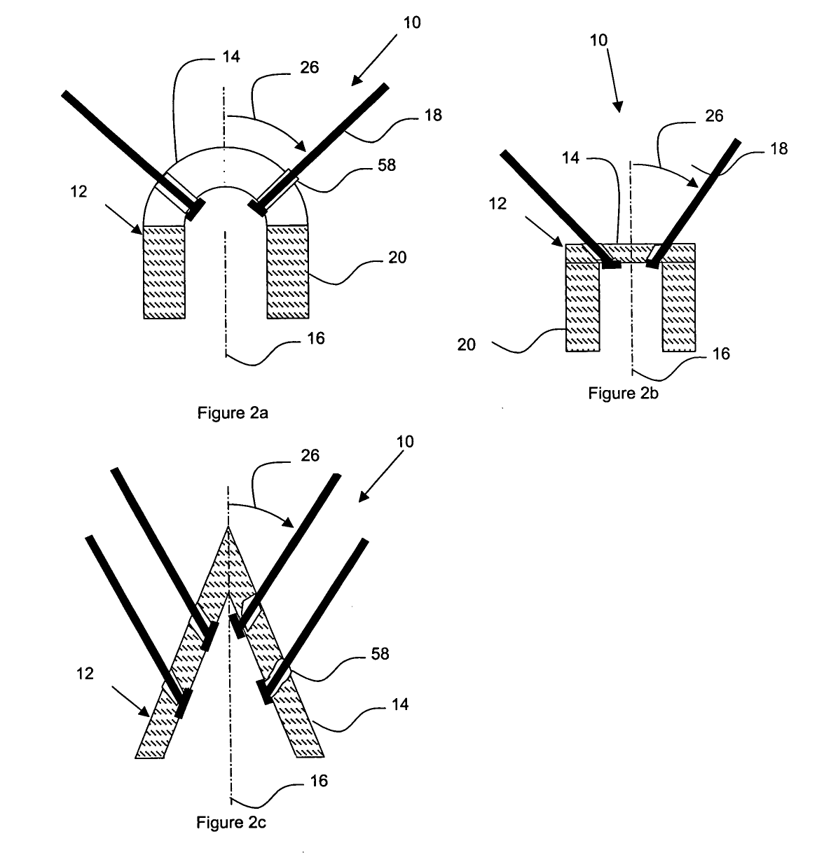

Hub face 14 may be planer, spherical, conical, parabolic, or a combination thereof. As shown in cross sectional FIG. 2a, hub face 14 may comprise a rounded or spherical surface from which a front flexible polymeric strand 18 extends in a longitudinal direction outward from hub face 14. Front polymeric strands may extend away from hub face 14 at a forward strand angle 26 which may be less than 90° relative to central axis 16. In the embodiment shown in FIG. 2b, hub face 14 may comprise a planer surface essentially perpendicular to central axis 16. In the embodiment shown in FIG. 2c, hub face 14 may comprise an at least partially conical surface radially disposed about central axis 16.

Forward strand angle 26 may be less than 90° relative to central axis 16. Within this range, forward strand angle 26 is preferably greater than about 5° and less than 90° relative to central axis 16. Forward strand angle 26 is preferably greater than 10°, and less than 80°, more preferably less than 70°, more preferably less than 60°, more preferably less than 50°, more preferably less than 40°, more preferably less than 30°, more preferably less than 20° relative to central axis 16.

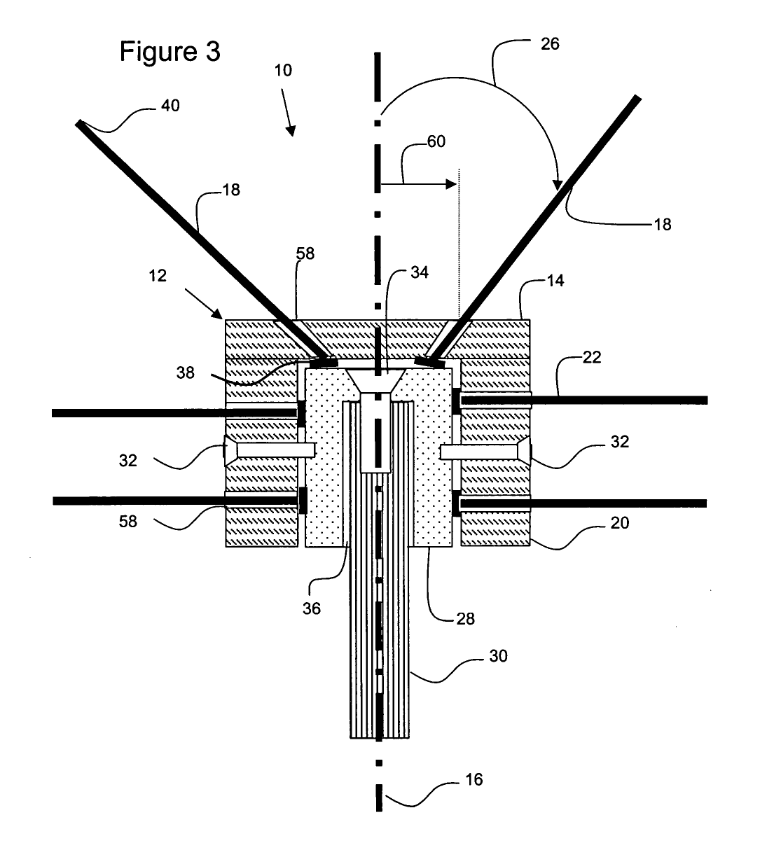

Referring to FIG. 3, which shows a cross sectional view of an embodiment of the present disclosure, brush 10 may comprise hub 12 having a plurality of sides 20 radially disposed about central axis 16. The plurality of sides 20 may each be attached to hub face 14, which may be arranged to intersect central axis 16. At least one front polymeric strand 18 may extend from hub face 14 at front strand angle 26. Hub 12 may be dimensioned to fit over, and preferably be secured to an inner hub 28. Inner hub 28 preferably includes a center cavity for receiving a rotatable shaft 30 (i.e., a hole or other shaped indentation which may engage rotatable shaft 30). As shown in the embodiment depicted in FIG. 3, hub 12 may be secured to (i.e., attached to) inner hub 28 by a frictional fit, by one or more threaded members 32, by one or more rivets, by an adhesive (not shown), or the like. Inner hub 28 may be attached to rotatable shaft 30 by a threaded member 34, by a threaded nut extending through inner hub 28 (not shown), by an adhesive 36 (e.g., a thermoplastic resin, a thermoset resin such as an epoxy), and/or the like.

As shown in FIG. 3, at least one front polymeric strand 18 (and/or at least one side polymeric strand 22) may comprise a free end 40 and an anchoring end 38 which may be larger in diameter than the remaining portion of the polymeric strand. Using front polymeric strand 18 as an example, anchoring end 38 may be used to engage front polymeric strand 18 with hub 12. As shown in FIG. 3, free end 40 of front polymeric strand 18 may extend through hub 12, while anchoring end 38, due to the increase in strand diameter, is retained within hub 12. Inner hub 28 may also engage and/or inhibit anchoring end 38 of front polymeric strand 18 from disengaging hub 12. Inner hub 28 may frictionally engage anchoring end 38, or may merely block egress of anchoring end 38. The same applies to the side polymeric strands 22. In another embodiment, at least one front polymeric strand 18, at least one side polymeric strand 22, or both, may be attached to hub 12 via an adhesive.

Accordingly, in an embodiment, front polymeric strands 18 and side polymeric strands 22 each have free end 40 and anchoring end 38, wherein anchoring end 38 has a larger diameter than free end 40; each free end 40 of front polymeric strands 18 and each free end 40 of side polymeric strands 22 protrudes through a strand opening 58 through hub 12, wherein strand opening 58 through hub 12 has a smaller diameter than the diameter of anchoring end 38 of front polymeric strands 18 and side strands 22, such that each of the anchoring ends 38 of front polymeric strands 18 and side strands 22 engages hub 12 and does not pass through strand openings 58 through hub 12. Preferably, hub 12 is positioned over inner hub 28 such that inner hub 28 frictionally engages at least one of anchoring ends 38 of front polymeric strands 18, side strands 22, or both.

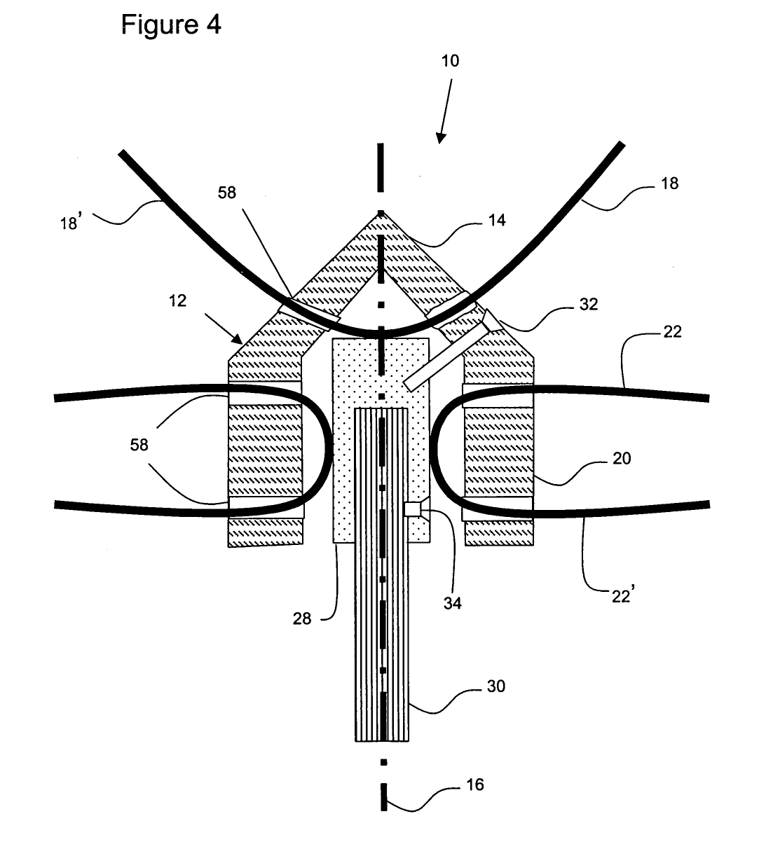

As shown in FIG. 4, two front polymeric strands 18 and 18′ and/or two side polymeric strands 22 and 22′ may comprise a single polymeric element, which may protrude through hub 12 in two separate locations. As is also shown in FIG. 4, inner hub 28 may compressionally engage front polymeric strand 18 and/or side polymeric strand 22 to hold the strands in place. Thus in an embodiment, brush 10 may comprise two or more front polymeric strands 18, wherein at least two of the front polymeric strands 18 are comprised from a single flexible monofilament polymeric chord which protrudes through hub face 14 through two separate strand openings 58. The same may be true for two or more side polymeric strands 22.

The polymeric strands of the present disclosure are preferably resilient materials which are sufficiently flexible to bend axially while accessing a duct's interior as well as being able to bend radially during a cleaning operation. In an embodiment, polymeric strands may comprise flexible monofilament elongated chords or lines, which may comprise thermoset resins, thermoplastic resins, or the like. Preferred examples include polyamide (nylon) weed trimmer line, including those disclosed in U.S. Pat. Nos. 4,047,299; 4,186,239; 4,118,865; 4,869,055; 4,905,465; 5,048,278, and the like, all of which are incorporated by reference herein. The average diameter of suitable polymeric strands is preferably about 0.040 inches to about 0.25 inches.

At least one front polymeric strand 18 is present on hub face 14. Preferably, front polymeric strands 18 occupy less than about 10% of the surface area of hub face 14. Within this range, front polymeric strands 18 preferably occupy less than about 5%, preferably less than about 1% of the surface area of hub face 14.

Taking for example a 0.1 inch diameter polymeric strand (area=0.008 in²) on a hub face 14 having about 7 in² surface area (e.g., a 3″ planer-circular hub face), at 1%, less than 8 front polymeric strands would be present extending longitudinally away from hub face 14.

Front polymeric strands 18 are preferably arranged uniformly about hub face 14. In an embodiment as shown in FIG. 3, a plurality of front polymeric strands 18 are arranged radially about hub face 14 at a particular strand radius 60, wherein each of the front polymeric strands 18 are spaced essentially equidistant from one another about particular strand radius 60.

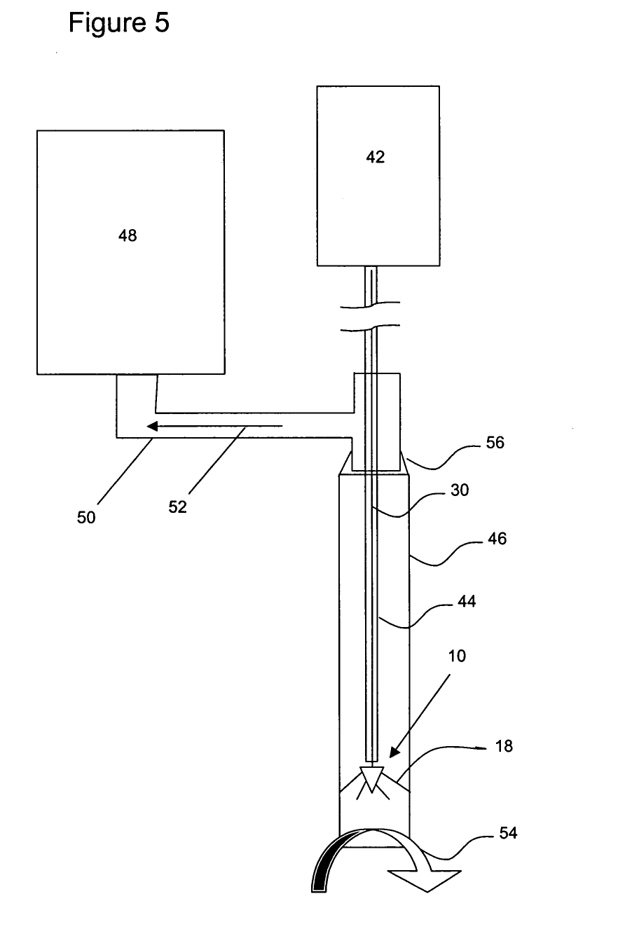

The front polymeric strands of the present disclosure may extend from hub face 14, at a forward strand angle 26 to a distance sufficient to contact the walls of the duct in which brush 10 is disposed (See FIG. 5). Preferably, front polymeric strands 18 may extend to a distance of about 0.25 to about 10 inches from said hub face. All of the front polymeric strands need not be of the same length.

In a preferred embodiment, at least one front polymeric strand 18 preferably extends 2 inches or less from hub face 14, preferably 1.5 inches or less, with about 1 inch or less being most preferred.

As shown in FIG. 5, brush 10 may be attached to rotatable shaft 30 which may be driven by a power source 42. Rotatable shaft 30 is preferably a flexible drive shaft, which leads directly from power source 42 to brush 10. Rotatable shaft 30 may also be disposed within a housing or sheath 44 to allow for rotation 54 of shaft 30 and subsequently brush 10 within a duct 46. A vacuum source 48 may also be attached to duct 46 via vacuum conduit 50 to direct debris (indicated by arrow 52) removed by brush 10 out of duct 46. Vacuum conduit 50 may abut duct 46 and sealing engage duct 46 by use of an adapter 56.

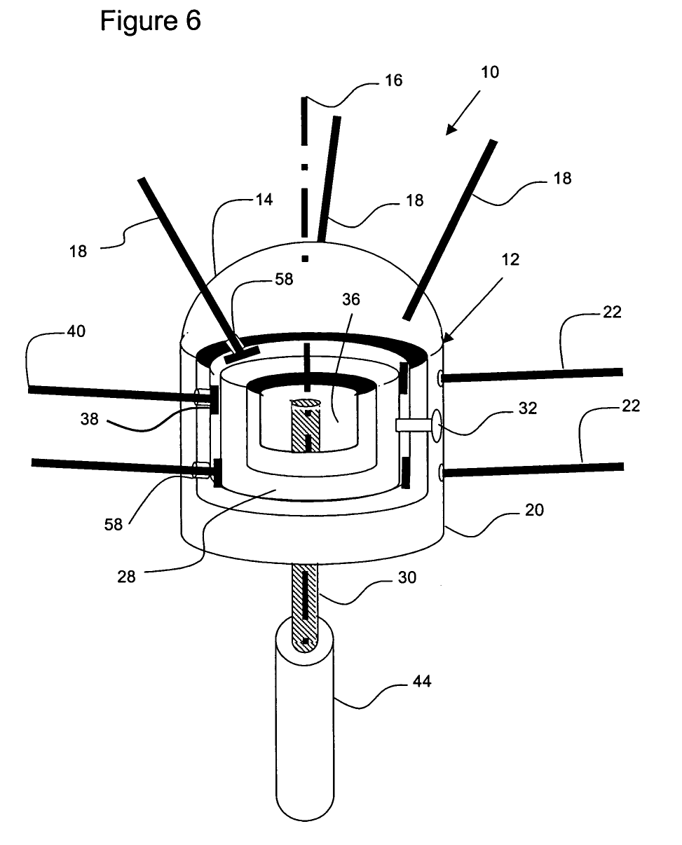

FIG. 6 shows a cutaway view of an embodiment of the present disclosure. In the embodiment shown in FIG. 6, hub face 14 is spherical, and front polymeric strands 18 are uniformly arranged about central axis 16.

Brush 10 of the present disclosure may also be utilized in a system wherein the vacuum hose is arranged proximate to brush 10, as disclosed in U.S. Pat. Nos. 6,813,810, 6,269,519, 5,608,941, and the like. All of which are incorporated in their entirety by reference herein for the purposes of U.S. Patent practice.

It should be understood, of course, that the foregoing relates to preferred embodiments of the disclosure and that modifications may be made without departing from the spirit and scope of the invention as set forth in the following claims.

We claim:

1. A duct cleaning brush comprising:
a hub having a hub face connecting a plurality of hub sides radially disposed about a central axis and at least one front polymeric strand extending in a longitudinal direction outward from said hub face.

2. The duct cleaning brush of claim 1, wherein said front polymeric strand extends outward from said hub face at a forward strand angle of less than 90 degrees, wherein said forward strand angle is determined between said front polymeric strand and said central axis.

3. The duct cleaning brush of claim 2, wherein said front strand angle is about 10° to about 70°.

4. The duct cleaning brush of claim 1, wherein a plurality of front polymeric strands occupy about 10% or less of the surface area of said hub face.

5. The duct cleaning brush of claim 1, wherein said hub comprises at least 3 hub sides.

6. The duct cleaning brush of claim 1, wherein said hub has an essentially circular cross section taken perpendicular to said central axis.

7. The duct cleaning brush of claim 1, wherein said hub face is planer, spherical, conical, parabolic, or a combination thereof.

8. The duct cleaning brush of claim 1, wherein said hub is attachable to a rotatable shaft.

9. The duct cleaning brush of claim 1, wherein said front polymeric strand comprises a flexible monofilament polymeric chord having an average diameter of about 0.040 inches to about 0.25 inches.

10. The duct cleaning brush of claim 1, wherein said front polymeric strand extends to a distance of about 0.25 to about 10 inches from said hub face.

11. The duct cleaning brush of claim 1, comprising two or more front polymeric strands, wherein at least two of the front polymeric strands are comprised from a single flexible monofilament polymeric chord which protrudes through said hub face through two separate strand openings.

12. The duct cleaning brush of claim 1, wherein a plurality of said front polymeric strands are arranged radially about said hub face at a particular radius, and wherein each of said front polymeric strands are spaced essentially equidistant from one another about said particular radius.

13. The duct cleaning brush of claim 1, wherein said at least one front polymeric strand is a flexible monofilament polymeric chord comprising a polyamide, a polyolefin, or a combination thereof.

14. The duct cleaning brush of claim 1, further comprising at least one side strand extending radially away from said hub side in a direction opposite said central axis.

15. The duct cleaning brush of claim 14, wherein said at least one side strand comprises a flexible monofilament polymeric chord having an average diameter of about 0.040 inches to about 0.25 inches.

16. The duct cleaning brush of claim 1, wherein said at least one front polymeric strand protrudes through a strand opening in said hub face, is attached to said hub face with an adhesive, or a combination thereof.

17. The duct cleaning brush of claim 1, wherein the hub is positioned over, and secured to an inner hub having a center cavity for receiving a rotatable shaft.

18. The duct cleaning brush of claim 17, further comprising at least one side strand extending radially away from said hub side, wherein said at least one side strand and said at least one front polymeric strand each comprise a flexible monofilament polymeric chord having an average diameter of about 0.040 inches to about 0.25 inches.

19. A duct cleaning brush comprising an inner hub having a center cavity for receiving a rotatable shaft;
an hub positioned over, and secured to said inner hub;
said hub having a hub face connecting a plurality of hub sides radially disposed about a central axis;
a plurality of front polymeric strands extending in a longitudinal direction outward from said hub face;
a plurality of side strands extending radially away from said hub side;
said front polymeric strands and said side strands comprise a flexible monofilament polymeric chord having an average diameter of about 0.040 inches to about 0.25 inches;
said front polymeric strands and said side strands each having a free end and an anchoring end, wherein said anchoring end has a larger diameter than said free end;
each free end of said front polymeric strands and each free end of said side strands protruding through a strand opening through said hub, wherein said strand opening through said hub has a smaller diameter than the diameter of said anchoring end of said front polymeric strands and said side strands such that each of said anchoring ends of said front polymeric strands and said side strands engages said hub and does not pass through said strand openings through said hub; and
said hub being positioned over said inner hub such that said inner hub frictionally engages at least one of said anchoring ends of said front polymeric strands, said side strands, or both.

20. A method of cleaning a duct comprising the steps of:
disposing a duct cleaning brush within said duct, wherein said duct cleaning brush comprises a hub having a hub face connecting a plurality of hub sides radially disposed about a central axis and at least one front polymeric strand extending in a longitudinal direction outward from said hub face, and
rotating said duct cleaning brush about said central axis within said duct such that said at least one front polymeric strand frictionally engages an inner wall of said duct.
